(19) United States
(12) Patent Application Publication
(10) Pub. No.: US 2011/0043996 A1
(43) Pub. Date: Feb. 24, 2011

(54) COMPUTER ENCLOSURE AND BRACKET OF THE COMPUTER ENCLOSURE FOR POWER SUPPLY AND HARD DISK DRIVE

(75) Inventors: XIAO-ZHU CHEN, Shenzhen City (CN); ZHEN-XING YE, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/551,482

(22) Filed: Aug. 31, 2009

(30) Foreign Application Priority Data
Aug. 18, 2009 (CN) 200910305745.8

(51) Int. Cl. G06F 1/16

(52) U.S. Cl. 361/679.58; 361/679.33

(57) ABSTRACT

A computer enclosure includes a compact disc (CD) drive bracket arranged on an end of an inner side thereof and a bracket mounting area formed on an end of a back panel thereof. The disclosure provides a bracket accommodated in the computer enclosure and arranged between the CD drive bracket and the bracket mounting area. The bracket is used to mount a power supply and a hard disk drive (HDD).

### BACKGROUND

1. Technical Field

The present disclosure relates to computer enclosures and, particularly, to a computer enclosure with a bracket for holding a power supply and a hard disk drive (HDD).

2. Description of Related Art

Referring to FIG. 1, an ordinary computer enclosure 10 may include a power supply 12 arranged in a top of a back panel of the computer enclosure, a compact disc (CD) drive bracket 14 arranged in a top of a front panel of the computer enclosure 10, and an HDD bracket 16 arranged in a middle of the front panel. The power supply 12 approximately faces the CD drive bracket 14. Although an inner fan of the power supply 12 may dissipate heat for a CD drive mounted in the CD drive bracket 14, the heat dissipating efficiency of the inner fan for the CD drive is low because the CD drive is far away from the power supply 12. In addition, a space between the power supply 12 and the CD drive bracket 14 is unused, which is a waste of space of the computer enclosure 10.

### BRIEF DESCRIPTION OF THE DRAWINGS

FIG. 1 is an isometric view of an ordinary computer enclosure.

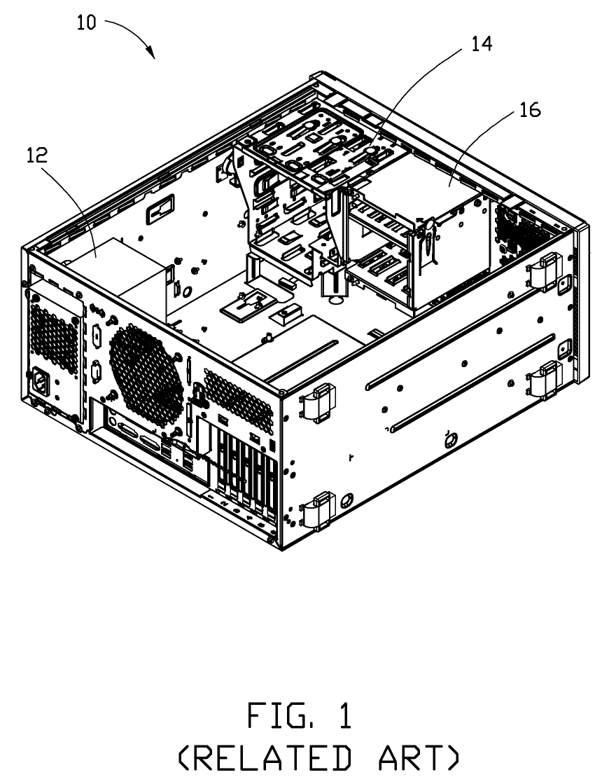

FIG. 2 is an exploded, isometric view of an exemplary embodiment of a computer enclosure including a bracket.

FIG. 3 is an enlarged, isometric view of the bracket of FIG. 2, but viewed from another perspective.

FIG. 4 is an assembled, isometric view of the computer enclosure of FIG. 1, together with a hard disk drive, but viewed from another perspective.

### DETAILED DESCRIPTION

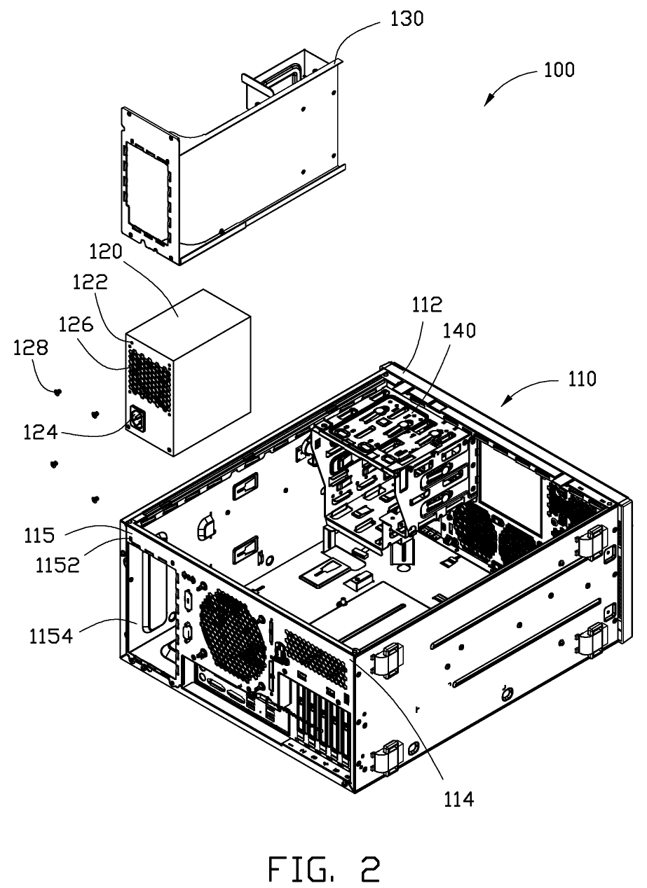

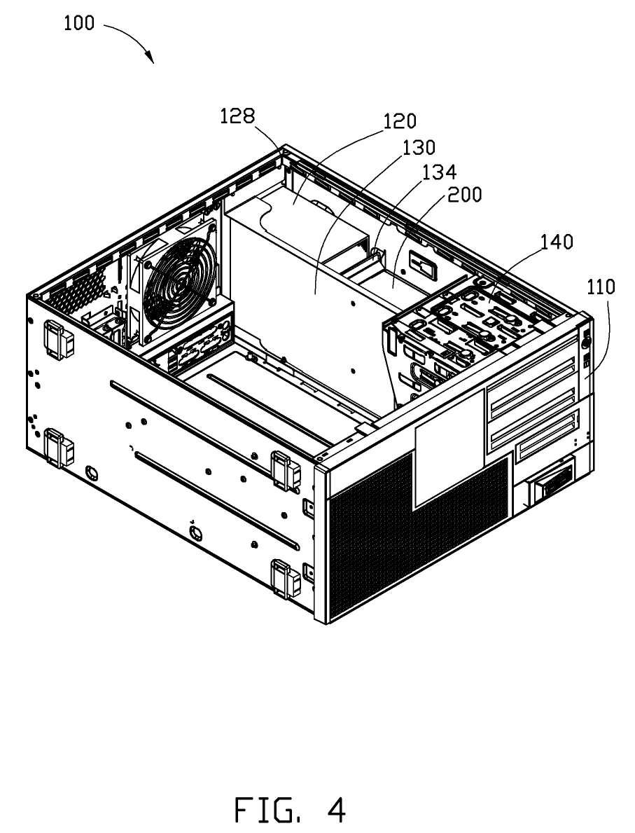

Referring to FIG. 2, an exemplary embodiment of a computer enclosure 100 includes a case 110, a power supply 120, and a bracket 130 to hold the power supply 120 and a hard disk drive (HDD) 200 (see FIG. 4) in the case 110.

The case 110 includes a front panel 112 and a back panel 114 opposite the front panel 112. A compact disc (CD) drive bracket 140 is arranged on a first end of an inner side of the front panel 112 facing the back panel 114. A bracket mounting area 115 is formed on a first end of the back panel 114. Four mounting holes 1152 are defined in four corners of the bracket mounting area 115. An opening 1154 is defined in a center of the bracket mounting area 115.

The power supply 120 defines four screw holes 112 in four corners of a back wall of the power supply 120, corresponding to the four mounting holes 1152 of the back panel 114. An electrical connector 124 is formed on a lower part of the back wall of the power supply 120. A plurality of heat dissipating holes 126 are defined in an upper part of the back wall of the power supply 120. The power supply 120 may include an inner fan (not show) arranged in the power supply 120, the inner fan dissipating heat for the power supply 120, and also blowing wind outside of the power supply through a front side opposite to the back wall of the power supply 120.

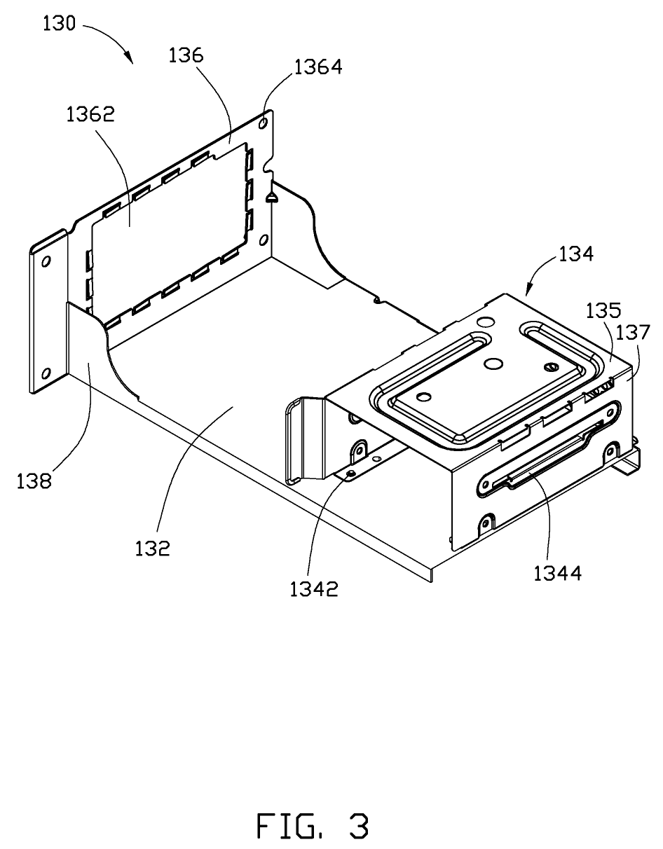

Referring to FIG. 3, the bracket 130 includes a rectangular-shaped supporting board 132. A mounting rack 134 is positioned on a first end of the supporting board 132 for mounting the HDD 200. A rectangular-shaped fixing board 136 vertically extends from a second end opposite to the first end of the supporting board 132. Two reinforcing ribs 138 are connected to the supporting board 132 and the fixing board 136.

The mounting rack 134 is generally U-shaped, and includes a first wall 135 opposite to the supporting board 132 and two second walls 137 perpendicularly extending from opposite sides of the first wall 135 to connect to the supporting board 132. The second walls 137 are fixed to the supporting board 132 via screws 1342 extending through the second walls 137 to engage with the supporting board 132. Two tabs 1344 extend from inner sides of the second walls 137 for supporting the HDD 200. In other embodiments, the number of the tabs 1344 can be increased for supporting more HDDs.

The fixing board 136 defines an opening 1362 therein, corresponding to the opening 1154 of the back panel 114 of the case 110. Four through holes 1164 are defined in four corners of the fixing board 136, corresponding to the mounting holes 1152 of the back panel 114.

Referring to FIG. 4, in assembly, the bracket 130 is placed in the case 110, with the through holes 1364 of the fixing board 136 aligning with the mounting holes 1152 of the back panel 114. The power supply 120 is attached to the supporting board 132, with the screw holes 122 of the power supply 120 aligning with the through holes 1364 of the fixing board 136. Four screws 128 are extended through the mounting holes 1152 of the back panel 114 and the through holes 1364 of the fixing board 136, to be screwed in the screw holes 122 of the power supply 120, respectively. Thereby, the bracket 130 with the power supply 120 is fixed in the case 110. The plurality of heat dissipating holes 126 and the electrical connector 124 are exposed through the opening 1362 of the fixing board 136 and the opening 1154 of the back panel 114. The HDD 200 is inserted into the mounting rack 134 to be supported on the tabs 1344.

Space between the power supply 120 and the CD drive bracket 140 is used to arrange the HDD 200. In addition, airflow from the inner fan of the power supply 120 through the front side of the power supply 120 may dissipate heat from the HDD 200, which can increase heat dissipating efficiency of the computer enclosure 100.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A computer enclosure, comprising:
a case comprising a front panel, a back panel opposite to the front panel, and a compact disc (CD) drive bracket arranged on an end of an inner side of the front panel, wherein a bracket mounting area is formed on an end of the back panel of the case, the bracket mounting are is opposite to the CD drive bracket;
a power supply comprising an electrical connector; and
a bracket accommodated in the case and arranged between the CD drive bracket and the bracket mounting area, the bracket comprising:
a supporting board;
a mounting rack positioned on a first end adjacent to the CD drive bracket of the supporting board, for mounting a hard disk drive (HDD); and
a fixing board extending from a second end opposite to the first end of the supporting board, wherein the power supply is position to the second end of the supporting board and the fixing board, the fixing board is fixed to the bracket mounting area of the case and the electrical connector of the power supply is exposed outside of the case through the back panel.

2. The computer enclosure of claim 1, wherein two reinforcing ribs are formed between the supporting board and the fixing board.

3. The computer enclosure of claim 1, wherein the mounting rack comprises a first wall opposite to the supporting board, and two second walls substantially perpendicularly extending from opposite sides of the first wall to connect to the supporting board, the supporting board, the first wall, and the second walls bound a space for accommodating the HDD.

4. The computer enclosure of claim 1, wherein the bracket mounting area of the case defines a first opening, the fixing board defines a second opening corresponding to the first opening, the electrical connector of the power supply is exposed outside of the case through the first and second openings.

5. The computer enclosure of claim 1, wherein four mounting holes are defined on four corners of the bracket mounting area of the case, four through holes are defined four corners of the fixing board corresponding to the four mounting holes of the bracket mounting area, the power supply defines four screw holes in four corners of a back wall of the power supply corresponding to the four mounting holes of the bracket mounting area, the fixing board is fixed to the bracket mounting area of the case via four screws being inserted through the mounting holes of the bracket mounting area and the through holes of the fixing board, to be engaged in the screw holes of the power supply.

6. A bracket for being arranged between a compact disc (CD) drive bracket mounted to a front panel of a computer enclosure and a back panel of the computer enclosure, the bracket comprising:
a supporting board;
a mounting rack positioned on a first end adjacent to the CD drive bracket of the supporting board for mounting a hard disk drive (HDD); and
a fixing board substantially vertically extending from a second end of the supporting board and adjacent to the back panel, wherein the second end of the supporting board and the fixing board is operable to position a power supply therebetween, the fixing board is operable to be fixed to the back panel with an electrical connector of the power supply exposing outside of the case through the back panel.

7. The bracket of claim 6, wherein two reinforcing ribs are formed between the supporting board and the fixing board.

8. The bracket of claim 6, wherein the mounting rack comprises a first wall opposite to the supporting board, and two second walls substantially perpendicularly extending from opposite sides of the first wall to connect to the supporting board, the supporting board, the first wall, and the second walls bound a space to receive the HDD.

9. The bracket of claim 6, wherein the fixing board defines a first opening therein, for the electrical connector of the power supply extending through the fixing board to expose outside of the case.

10. The bracket of claim 6, wherein four through holes are defined the fixing board, to fix the fixing board to the back panel via screws.
